(19) United States
(12) Patent Application Publication
(10) Pub. No.: US 2025/0230103 A1
(43) Pub. Date: Jul. 17, 2025

(54) CERAMIC ELECTRONIC DEVICE AND MANUFACTURING METHOD OF THE SAME

(71) Applicant: TAIYO YUDEN CO., LTD., Tokyo (JP)

(72) Inventor: Junichi SHINOZAKI, Tokyo (JP)

(73) Assignee: TAIYO YUDEN CO., LTD., Tokyo (JP)

(21) Appl. No.: 18/985,921

(22) Filed: Dec. 18, 2024

(30) Foreign Application Priority Data
Jan. 15, 2024 (JP) 2024-004010

(51) Int. Cl. C04B 35/64; H01G 4/008; H01G 4/012; H01G 4/30

(52) U.S. Cl. CPC C04B 35/64; H01G 4/008; H01G 4/012; C04B 2235/6581; H01G 4/30

(57) ABSTRACT

A multilayer chip includes side margins outside of a capacity section in a third direction which is orthogonal to a first direction in which plurality of internal layers face each other and a second direction in which two end faces are opposite to each other. A first internal layer and a second internal layer are included in the capacity section and include a metal component. The first internal layer includes a protruding section which protrudes toward outside from the capacity section in the third direction. The protruding section includes an oxidized portion of the metal component. A relationship dₒ₁>dₒ₂ is satisfied when a length of the oxidized portion of the protruding section is dₒ₁ and a length of an oxidized portion at an end of the second internal layer on a side of one of the side margins is dₒ₂.

### CROSS-REFERENCE TO RELATED APPLICATION

This application is based upon and claims the benefit of priority of the prior Japanese Patent Application No. 2024-004010, filed on Jan. 15, 2024, the entire contents of which are incorporated herein by reference.

### FIELD

A certain aspect of the present disclosure relates to a ceramic electronic device and a manufacturing method of the ceramic electronic device.

### BACKGROUND

Ceramic electronic components such as multilayer ceramic capacitors are used in high-frequency communication systems such as mobile phones (see, for example, Japanese Patent Application Publication No. 2014-204113).

### SUMMARY OF THE INVENTION

According to an aspect of the embodiments, there is provided a ceramic electronic device including: a multilayer chip including a multilayer portion in which each of a plurality of dielectric layers and each of a plurality of internal layers are alternately stacked; wherein each of the plurality of internal layers is alternately extracted to two end faces of the multilayer chip opposite to each other, wherein the multilayer chip includes side margins outside of a capacity section in a third direction which is orthogonal to a first direction in which the plurality of internal layers face each other and a second direction in which the two end faces are opposite to each other, the capacity section being a section in which the plurality of internal layers face each other, wherein the plurality of internal layers include a first internal layer and a second internal layer which are included in the capacity section and include a metal component, wherein the first internal layer includes a protruding section which protrudes toward outside from the capacity section in the third direction, wherein the protruding section includes an oxidized portion of the metal component, and wherein a relationship dₒ₁>dₒ₂ is satisfied when a length of the oxidized portion of the protruding section is dₒ₁ and a length of an oxidized portion at an end of the second internal layer on a side of one of the side margins is dₒ₂ in a cross section along the second direction and the third direction.

According to another aspect of the embodiments, there is provided a manufacturing method of a ceramic electronic device including: forming an internal electrode pattern on each of dielectric green sheets; forming a dielectric pattern around the internal electrode pattern on each of the dielectric green sheets; obtaining a multilayer structure by, in a first direction, stacking each of the dielectric green sheets on which the internal electrode pattern and the dielectric pattern are formed, so that an end of the internal electrode pattern is alternately shifted in a second direction, and at least two of the internal electrode pattern adjacent to each other is shifted in a third direction orthogonal to the first direction and the second direction; performing a first firing of the multilayer structure; performing a vacuum pulse firing of the multilayer structure after the first firing; and performing a second firing of the multilayer structure after the vacuum pulse firing, at an oxygen partial pressure higher than that of the first firing.

### BRIEF DESCRIPTION OF THE DRAWINGS

FIG. 1 is a partial cross-sectional perspective view of a multilayer ceramic capacitor;

FIG. 2 is a cross-sectional view taken along line A-A in FIG. 1;

FIG. 3 is a cross-sectional view taken along line B-B in FIG. 1;

FIG. 4 is an enlarged cross-sectional view of a vicinity of an external electrode;

FIG. 5 is a schematic cross-sectional view for explaining details of a stack structure in a multilayer ceramic capacitor;

FIG. 6A and FIG. 6B are partially enlarged views of FIG. 5;

FIG. 7 illustrates effects of an embodiment;

FIG. 8 is a diagram illustrating a case where a first protruding section of a first internal layer extends in a direction different from a Y-axis direction;

FIG. 9 illustrates a case where an oxidized portion is interrupted;

FIG. 10 illustrates a flow of a manufacturing method of a multilayer ceramic capacitor;

FIG. 11A illustrates a forming process of an internal electrode;

FIG. 11B illustrates a stacking process;

FIG. 12A and FIG. 12B illustrates effects of a manufacturing method;

FIG. 13 illustrates a second embodiment;

FIG. 14A is an enlarged view of a vicinity of an uppermost second internal layer in a first side margin;

FIG. 14B is an enlarged view of a vicinity of an uppermost first internal layer in a first side margin;

FIG. 15 illustrates a third embodiment;

FIG. 16A is a graph illustrating a relationship between dₒ₁/d_{w} and a number of failures in a high-temperature load test;

FIG. 16B is a graph illustrating a relationship between d_{w}/d_{T} and a number of failures in a high-temperature load test; and

FIG. 16C is a graph illustrating results of FIG. 16A and FIG. 16B.

### DETAILED DESCRIPTION

Ceramic electronic devices such as multilayer ceramic capacitors are required to have thinner dielectric layers, thinner internal electrode layers, maximized area of the internal electrode layers (minimized margins), and higher stacking in order to meet market demands for large capacity and small size.

However, thinner dielectric layers are accompanied by an increase in electric field strength. Therefore, the solid solution state of slight amount additives in the dielectric material may be controlled by sintering conditions such as sintering temperature and atmosphere. Here, if the oxygen partial pressure is high, oxygen penetrates the internal electrode layer, which causes local oxidation of the internal electrode layer and the associated diffusion and segregation of metal elements added to the internal electrode layer and dielectric layer, which can easily cause deterioration of characteristics. In addition, maximizing the area of the internal electrode layer (minimizing the margin) shortens the distance between the ceramic device surface and the internal electrode layer (the oxygen penetration path), making the above problem even more likely to occur. In particular, oxygen is more likely to penetrate between the internal electrode layers on the side surface than on the cover surface, making the above problem more likely to occur.

In response to this, it is possible to suppress the oxidation of the internal electrode layer by adding a noble metal component to the internal electrode material or by ensuring a margin amount. However, noble metals are valuable and expensive, which can lead to problems with securing materials and profitability. And in recent years, ceramic electronic devices are required to be made smaller in size and larger in capacity, so methods that ensure a margin amount can cause problems such as limited effective capacity section.

Hereinafter, an exemplary embodiment will be described with reference to the accompanying drawings.

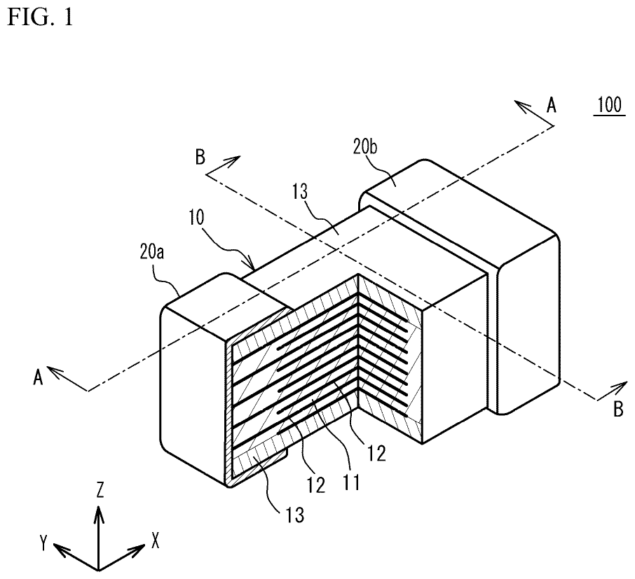

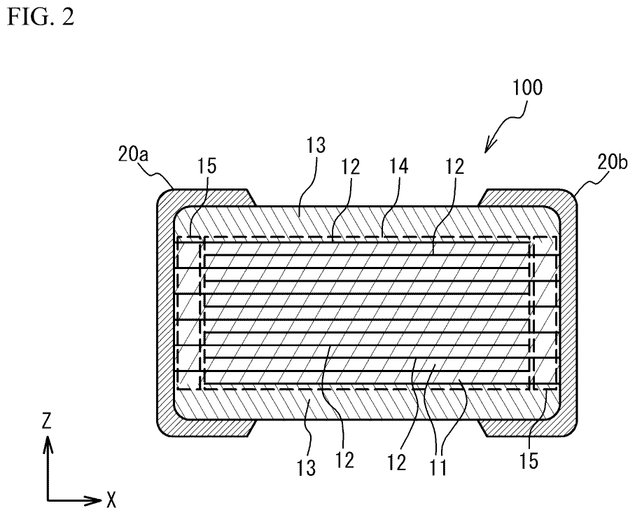

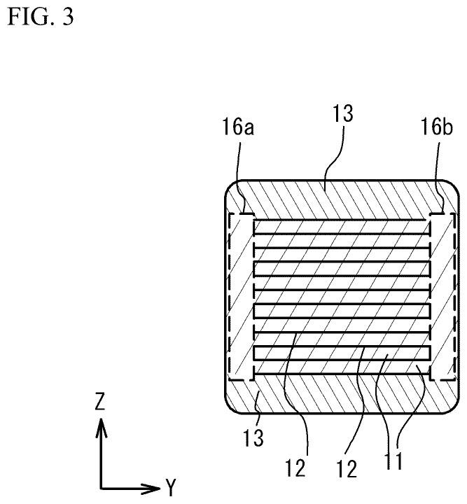

(First Embodiment) A description will be given of an outline of a multilayer ceramic capacitor 100 in accordance with a first embodiment. FIG. 1 illustrates a perspective view of the multilayer ceramic capacitor 100, in which a cross section of a part of the multilayer ceramic capacitor 100 is illustrated. FIG. 2 is a cross-sectional view taken along line A-A in FIG. 1. FIG. 3 is a cross-sectional view taken along line B-B in FIG. 1. As illustrated in FIG. 1 to FIG. 3, the multilayer ceramic capacitor 100 includes a multilayer chip 10 having a rectangular parallelepiped shape, and external electrodes 20a and 20b that are respectively provided on two end faces of the multilayer chip 10 facing each other. Among four faces other than the two end faces of the multilayer chip 10, two faces other than the upper face and the lower face in the stacking direction are referred to as side faces. Each of the external electrodes 20a and 20b extends to the upper face and the lower face in the stacking direction and the two side faces of the multilayer chip 10. However, the external electrodes 20a and 20b are spaced from each other.

In FIG. 1 to FIG. 3, a Z-axis direction (first direction) is the stacking direction. The Z-axis direction is a direction in which internal electrode layers face each other. An X-axis direction (second direction) is a longitudinal direction of the multilayer chip 10. The X-axis direction is a direction in which the two end faces of the multilayer chip 10 are opposite to each other and in which the external electrode 20a is opposite to the external electrode 20b. A Y-axis direction (third direction) is a width direction of the internal electrode layers. The Y-axis direction is a direction in which the two side faces of the multilayer chip 10 are opposite to each other. The X-axis direction, the Y-axis direction and the Z-axis direction are vertical to each other.

The multilayer chip 10 has a structure designed to have dielectric layers 11 and internal layers 12 alternately stacked. The dielectric layer 11 contains a ceramic material acting as a dielectric material. End edges of the internal layers 12 are alternately exposed to a first end face of the multilayer chip 10 and a second end face of the multilayer chip 10 that is different from the first end face. The external electrode 20a is provided on the first end face. The external electrode 20b is provided on the second end face. Thus, the internal layers 12 are alternately electrically connected to the external electrode 20a and the external electrode 20b. Accordingly, the multilayer ceramic capacitor 100 has a structure in which a plurality of the dielectric layers 11 are stacked with the internal layers 12 interposed therebetween. In the multilayer structure of the dielectric layers 11 and the internal layers 12, the outermost layers in the stack direction are the internal layers 12, and cover layers 13 cover the top face and the bottom face of the multilayer structure. The cover layer 13 is mainly composed of a ceramic material. For example, the main component of the cover layer 13 may be the same as the main component of the dielectric layer 11 or may be different from the main component of the dielectric layer 11.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

The main component of the internal layer 12 is not particularly limited, but is a base metal such as Ni (nickel), Cu (copper), Sn (tin). As a main component of the internal layers 12, noble metals such as Pt (platinum), Pd (palladium), Ag (silver), Au (gold), and alloys containing these may be used. It is preferable that the average thickness per layer of the internal layer 12 in the Z-axis direction is, for example, 0.5 μm or less, or 0.4 μm or less. The thickness of the internal layer 12 is determined by observing the cross section of the multilayer ceramic capacitor 100 with a SEM (scanning electron microscope), measuring the thickness at 10 points for each of the 10 different internal layers 12, and calculating the average value of all the measurement points.

A main component of the dielectric layer 11 is a ceramic material having a perovskite structure expressed by a general formula ABO₃. The perovskite structure includes ABO_{3-α} having an off-stoichiometric composition. For example, the ceramic material is such as BaTiO₃ (barium titanate), CaZrO₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr_{z}O₃ (0≤x≤1, 0≤y≤1, 0≤z≤1) having a perovskite structure. Ba_{1-x-y}CaₓSr_{y}Ti_{1-z}Zr_{z}O₃ may be barium strontium titanate, barium calcium titanate, barium zirconate, barium titanate zirconate, calcium titanate zirconate, barium calcium titanate zirconate or the like. For example, the concentration of the main component ceramic material in the dielectric layer 11 is 90 at % or more. The thickness of the dielectric layer 11 is, for example, 1.0 μm or less, or 0.8 μm or less. The thickness of the dielectric layer 11 is determined by observing the cross section of the multilayer ceramic capacitor 100 with a SEM (scanning electron microscope), measuring the thickness of each of the 10 different dielectric layers 11 at 10 points, and calculating the average value of all measurement points.

Additives may be added to the dielectric layer 11. As additives to the dielectric layer 11, zirconium (Zr), hafnium (Hf), magnesium (Mg), manganese (Mn), molybdenum (Mo), vanadium (V), chromium (Cr), rare earth elements (yttrium (Y), samarium (Sm), europium (Eu), gadolinium (Gd), terbium (Tb), dysprosium (Dy), holmium (Ho), erbium (Er), thulium (Tm), and ytterbium (Yb)) or an oxide of cobalt (Co), nickel (Ni), lithium (Li), boron (B), sodium (Na), potassium (K) or silicon (Si), or a glass including cobalt, nickel, lithium, boron, sodium, potassium or silicon.

As illustrated in FIG. 2, the section where the internal layers 12 connected to the external electrode 20a faces the internal layers 12 connected to the external electrode 20b is a section where capacity is generated in the multilayer ceramic capacitor 100. Thus, this section is referred to as a capacity section 14. That is, the capacity section 14 is a section where two adjacent internal layers 12 connected to different external electrodes face each other.

The section where the internal layers 12 connected to the external electrode 20a face each other with no internal layer 12 connected to the external electrode 20b interposed therebetween is referred to as an end margin 15. The section where the internal layers 12 connected to the external electrode 20b face each other with no internal layer 12 connected to the external electrode 20a interposed therebetween is also the end margin 15. That is, the end margin 15 is a section where the internal layers 12 connected to one of the external electrodes face each other with no internal layer 12 connected to the other of the external electrodes interposed therebetween. The end margin 15 is a section where no capacity is generated.

As illustrated in FIG. 3, in the multilayer chip 10, a side margin 16 is a section provided so as to cover the ends (ends in the Y-axis direction) of the two side faces of the dielectric layers 11 and the internal layers 12. That is, the side margin 16 is a section provided outside the capacity section 14 in the Y-axis direction. The side margin 16 is also a section where no capacity is generated.

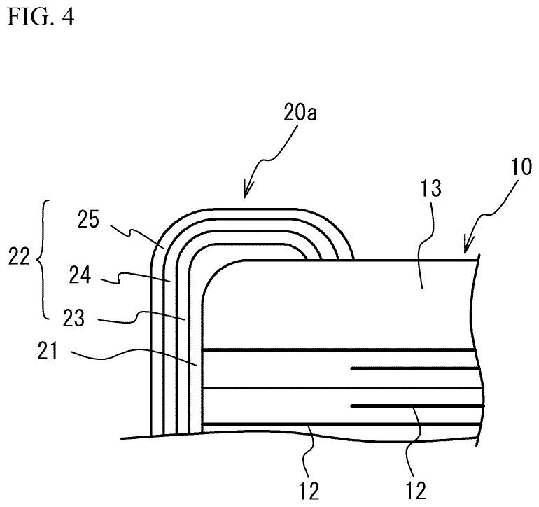

FIG. 4 is an enlarged cross-sectional view of the vicinity of the external electrode 20a. In FIG. 4, hatches are omitted. As illustrated in FIG. 4, a plated layer 22 may be provided on the outer surface of the external electrode 20a, using the external electrode 20a as a base layer. The external electrode 20a has Cu as a main component. The external electrode 20a may contain a glass component. The plated layer 22 mainly contains metals such as Cu, Ni, aluminum (Al), zinc (Zn), and Sn, or alloys of two or more of these metals. The plated layer 22 may be a plated layer of a single metal component, or may be a plurality of plated layers of mutually different metal components. For example, the plated layer 22 has a structure in which a first plated layer 23, a second plated layer 24, and a third plated layer 25 are formed in order from the external electrode 20a side. The first plated layer 23 is, for example, a Cu-plated layer. The second plated layer 24 is, for example, a Ni plated layer. The third plated layer 25 is, for example, a Sn-plated layer. Although FIG. 4 illustrates the external electrode 20a, the plated layer 22 may be similarly provided on the outer surface of the external electrode 20b.

The market demands large capacity and small size for the multilayer ceramic capacitor 100, and therefore it is required to make the dielectric layer 11 thinner, make the internal layer 12 thinner, maximize the opposing area between the internal layers 12 in the capacity section 14 (minimize the margin section), and increase the number of layers. However, making the dielectric layer 11 thinner is accompanied by an increase in the electric field strength. Therefore, the solid solution state of slight amount additives in the dielectric material may be controlled by the firing conditions such as the firing temperature and atmosphere. Here, if the oxygen partial pressure is high, oxygen will penetrate into the internal layer 12, and the characteristics are likely to deteriorate due to local oxidation of the internal layer 12 and the accompanying diffusion and segregation of the metal elements added to the internal layer 12 and dielectric layer 11. In addition, maximizing the opposing area between the internal layers 12 in the capacity section 14 (minimizing the margin section) shortens the distance (oxygen penetration path) between the ceramic component surface and the internal layer 12, making the above problem even more likely to occur. In particular, oxygen is more likely to penetrate between the internal layers 12 on the side surfaces of the Y-axis end faces than on the cover surfaces of the Z-axis end faces, and the above problems are more likely to occur.

In response to this, it is possible to suppress the oxidation of the internal layers 12 by adding a noble metal component to the internal electrode material or by ensuring a margin. However, noble metals are valuable and expensive, and there are problems with securing the materials and profitability. In addition, in recent years, there has been a demand for a large capacity and small size of the multilayer ceramic capacitor 100, and a method of ensuring a margin can cause problems in that the opposing area between the internal layers 12 in the capacity section 14 is limited.

Therefore, the multilayer ceramic capacitor 100 according to this embodiment has a configuration that can achieve a large capacity and small size at low cost. Details will be described below.

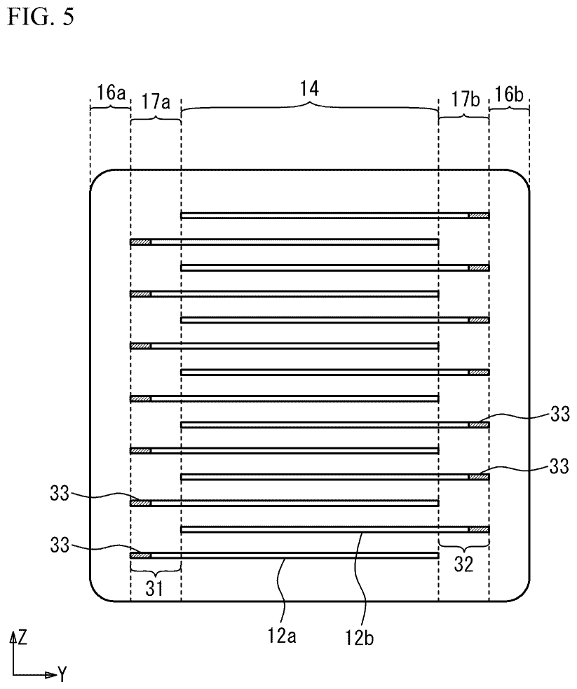

FIG. 5 is a schematic cross-sectional view for explaining the details of the stack structure in the multilayer ceramic capacitor 100. The cross-sectional view in FIG. 5 corresponds to a YZ cross-section. As illustrated in FIG. 5, among the internal layers 12 included in the multilayer ceramic capacitor 100, the first internal layer 12a protrudes toward the first side margin 16a more than the second internal layer 12b. Among the internal layers 12, the second internal layer 12b protrudes toward the second side margin 16b more than the first internal layer 12a. The first internal layers 12a and the second internal layers 12b are alternately stacked. In the first internal layer 12a, a section protruding toward the first side margin 16a more than the second internal layer 12b is referred to as a first protruding section 31. In the second internal layer 12b, a section protruding toward the second side margin 16b more than the first internal layer 12a is referred to as a second protruding section 32.

In the Y-axis direction, the first side margin 16a is located outside each of the first internal layers 12a. In other words, the first side margin 16a is located outside the first internal layer 12a located at the outermost position in the Y-axis direction among the first internal layers 12a. Between the first side margin 16a and the capacity section 14, the ceramic component and the first protruding section 31 are mixed. The section between the first side margin 16a and the capacity section 14 is referred to as a first mixed section 17a. On the other hand, in the Y-axis direction, the second side margin 16b is located outside the second internal layers 12b. In other words, the second side margin 16b is located outside the second internal layer 12b located at the outermost position in the Y-axis direction among the second internal layers 12b. Between the second side margin 16b and the capacity section 14, the ceramic component and the second protruding section 32 are mixed. The section between the second side margin 16b and the capacity section 14 is referred to as a second mixed section 17b. In the case where there is a variation in both ends of the first internal layer 12a and the second internal layer 12b in the Y-axis direction in the capacity section 14, the end of the capacity section 14 on the first side margin 16a side in the Y-axis direction is the end on the side of the first side margin 16a of the second internal layer 12b that extends furthest toward the first side margin 16a, and the end of the capacity section 14 on the second side margin 16b side in the Y-axis direction is the end on the side of the second side margin 16b of the first internal layers 12a that extends furthest toward the second side margin 16b.

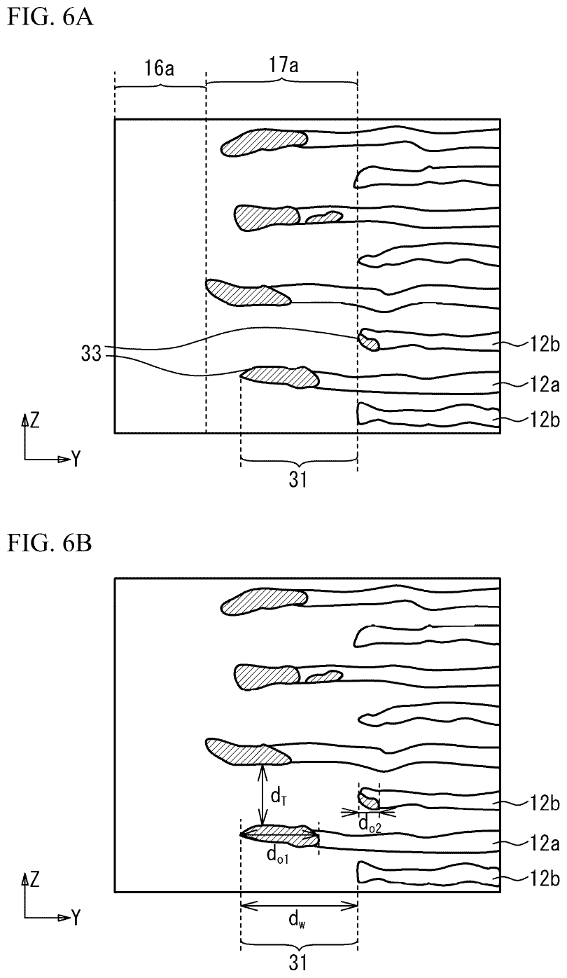

FIG. 6A is a partially enlarged view of FIG. 5. As illustrated in FIG. 5 and FIG. 6A, the first protruding section 31 has an oxidized portion 33 at the end on the first side margin 16a side. The oxidized portion 33 is an oxide of the main component metal of the first internal layer 12a and the second internal layer 12b. The second internal layer 12b may or may not have the oxidized portion 33 at the end on the first side margin 16a side. As illustrated in FIG. 5, the second protruding section 32 has the oxidized portion 33 at the end on the second side margin 16b side. The first internal layer 12a may or may not have the oxidized portion 33 at the end on the second side margin 16b side. In the YZ cross section, the first internal layer 12a and the second internal layer 12b have metal as a main component in the capacity section 14 and function as electrodes.

As illustrated in FIG. 6B, the length of the first protruding section 31 is d_{w}. The distance (shortest distance) between the first protruding section 31 of the first internal layer 12a and the first protruding section 31 of the adjacent first internal layer 12a is d_{T}. The length of the oxidized portion 33 of the first protruding section 31 is dₒ₁. The length of the oxidized portion 33 of the end of the second internal layer 12b on the first side margin 16a side is dₒ₂. The length directions of d_{w}, dₒ₁, and dₒ₂ are the directions in which the first protruding section 31 protrudes toward the inside of the first side margin 16a. d_{T} may be the average value of the shortest distances between the first protruding sections 31 of all the first internal layers 12a. In the internal layer, the EPMA can be used to identify the oxidized portion as a location where the main component metal and oxygen are present in synchronization in the internal layer.

In this embodiment, the relationship dₒ₁>dₒ₂ holds. If the second internal layer 12b does not have the oxidized portion 33, dₒ₂ is zero. According to this configuration, even if oxygen penetrates in the Y-axis direction from the side surface on the first side margin 16a side of the multilayer ceramic capacitor 100, the oxygen reaches the oxidized portion 33 of the first internal layer 12a before the second internal layer 12b. The oxygen that penetrates is used to advance the oxidation of the oxidized portion 33 before the metal region, so that the oxidized portion 33 captures the oxygen, making it difficult for the oxygen to reach the capacity section 14. This suppresses the oxidation of the metal components in the capacity section 14. In addition, since the first internal layers 12a are separated from each other, even if the oxidized portion 33 is formed in the first internal layer 12a, local structural deterioration is suppressed, and reliability deterioration and short circuits can be suppressed. In other words, the desired electrical characteristics can be realized.

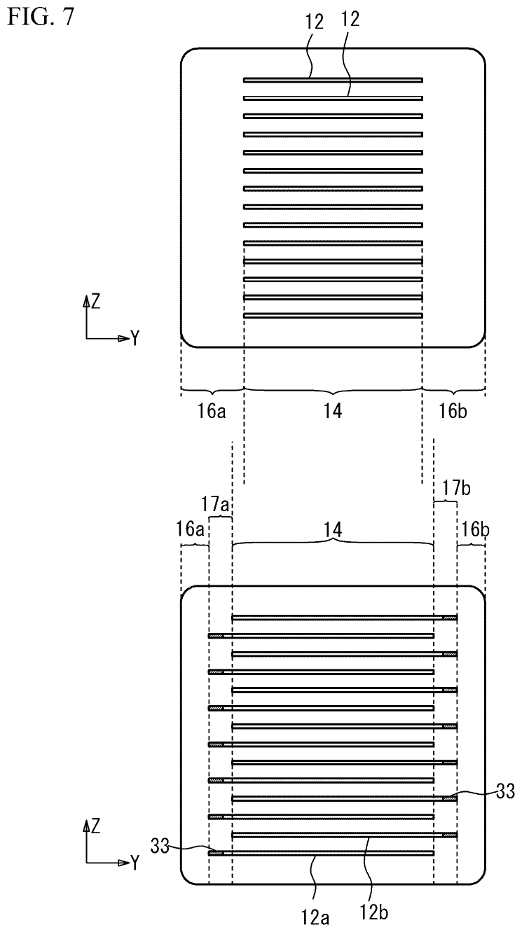

Next, the upper diagram of FIG. 7 illustrates a case where both ends of each internal layer 12 in the Y-axis direction are aligned, and no oxidized portion is provided at both ends of each internal layer 12 in the Y-axis direction. As illustrated in the upper diagram of FIG. 7, in this case, since no oxidized portion is provided to capture oxygen that has entered the first side margin 16a and the second side margin 16b, oxygen is more likely to reach the capacity section 14. Therefore, the first side margin 16a and the second side margin 16b must be made thicker in the Y-axis direction. In this case, the amount of margin increases, making it difficult to increase the capacity within a limited size.

In contrast, the lower diagram of FIG. 7 illustrates this embodiment. As illustrated in the lower diagram of FIG. 7, oxygen is less likely to reach the capacity section 14 because the oxidized portion 33 of the first protruding section 31 and the oxidized portion 33 of the second protruding section 32 can capture oxygen. As a result, the first side margin 16a and the second side margin 16b can be made thinner in the Y-axis direction. In addition, the first protruding section 31 and the second protruding section 32 are parts that do not contribute to the capacity because they contain a large amount of the oxidized portions 33, and therefore the distance (the oxygen intrusion path) between the ceramic component surface and the internal layer 12 is longer, so a first side margin 16a and a second side margin 16b can be made thinner in the Y-axis direction. In addition, not only can the side margins be made thinner, but by adopting this embodiment, the first internal layer 12a and the second internal layer 12b can be printed longer in the Y-axis direction, so that the intersection area between the first internal layer 12a and the first internal layer 12b can be increased, and a higher capacity than before can be realized. This makes it possible to increase the capacity in a limited size.

As described above, according to this embodiment, the desired electrical characteristics can be achieved without adding a large amount of noble metal to the internal layer, so that an inexpensive configuration can be achieved. In addition, the amount of margin can be reduced, so that a large capacity and a small size can be realized.

Next, refer to FIG. 6B again. The longer the first protruding section 31 is, the more oxygen can be captured by the first protruding section 31. Therefore, it is preferable that d_{w} is long. If d_{T} is small, the distance between the first protruding sections 31 of two adjacent first internal layers 12a becomes short. Therefore, it is preferable to define the lower limit of d_{w} in relation to d_{T}. In this embodiment, it is preferable that d_{T}×0.5<d_{w}, and it is more preferable that d_{T}<d_{w}.

The longer the oxidized portion 33 of the first protruding section is, the more oxygen can be captured by the first protruding section 31. For example, it is preferable that d_{T}×0.2<dₒ₁<d_{w}×1.0, and it is more preferable that d_{T}×0.5<dₒ₁<d_{w}×0.75.

In order to capture oxygen in the first protruding section 31, it is preferable that d_{w}/d_{T} is 50% or more and do1/dw is less than 100%. Note that the percentages here mean that when each ratio is 1, it is 100%.

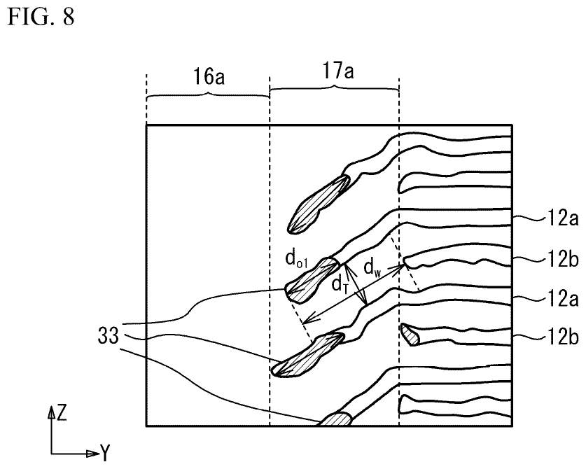

FIG. 8 is a diagram illustrating a case where the first protruding section 31 of the first internal layer 12a extends in a direction different from the Y-axis direction. In this case, the length d_{w} of the first protruding section 31 means the length between the end of the first internal layer 12a on the first side margin 16a side and the end of the second internal layer 12b on the first side margin 16a side in the direction in which the first protruding section 31 extends toward the first side margin 16a. In addition, the length dₒ₁ of the oxidized portion 33 of the first protruding section 31 means the length of the oxidized portion 33 of the first protruding section 31 in the direction in which the first protruding section 31 extends.

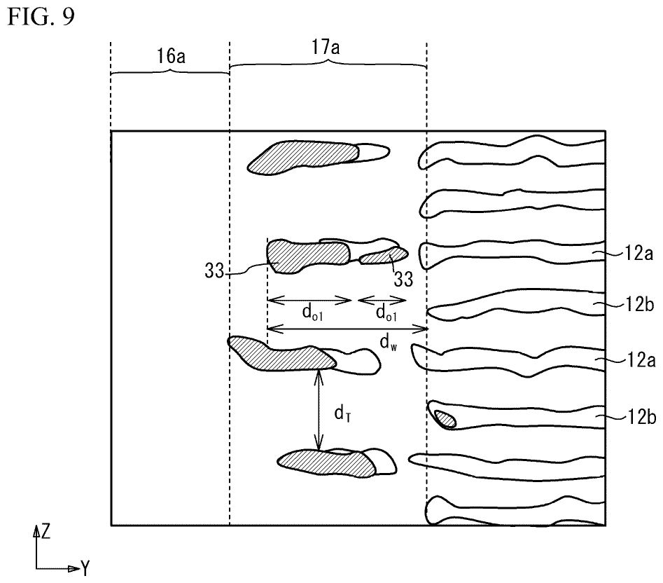

As illustrated in FIG. 9, in the first protruding section 31, the oxidized portion 33 may be interrupted in the Y-axis direction, forming a plurality of oxidized portions that are spaced apart from one another. In this case, the length dₒ₁ of the oxidized portion 33 may be defined as the sum of the lengths of the oxidized portions 33 in the first protruding section 31.

According to this embodiment, the first side margin 16a and the second side margin 16b can be thinned in the Y-axis direction. For example, in the Y-axis direction, the total thickness of the first side margin 16a and the first mixed section 17a, and the total thickness of the second side margin 16b and the second mixed section 17b are preferably 150 μm or less, and more preferably 70 μm or less. Alternatively, in the Y-axis direction, the total thickness of the first side margin 16a and the first mixed section 17a, and the total thickness of the second side margin 16b and the second mixed section 17b are preferably 5% or less, and more preferably 2% or less, of the width of the multilayer ceramic capacitor 100 in the Y-axis direction.

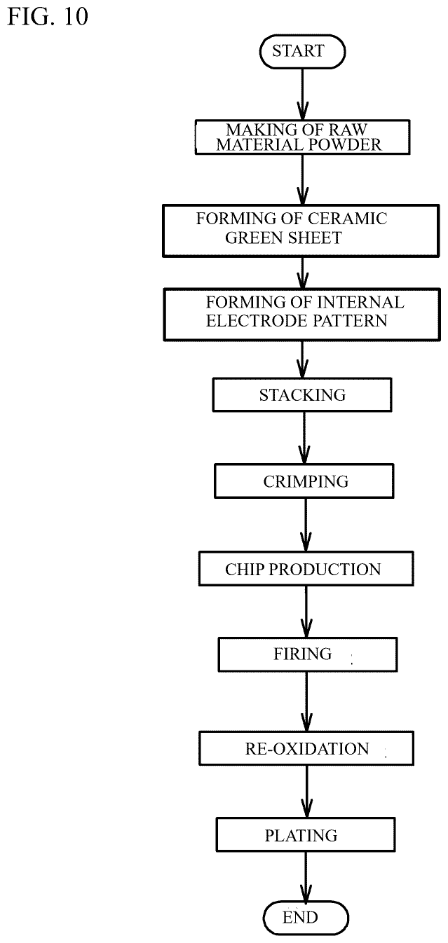

Next, a description will be given of a manufacturing method of the multilayer ceramic capacitors 100. FIG. 10 illustrates a manufacturing method of the multilayer ceramic capacitor 100.

(Making process of raw material powder) A dielectric material for forming the dielectric layer 11 is prepared. An A site element and a B site element are included in the dielectric layer 11 in a sintered phase of grains of ABO₃. For example, barium titanate is tetragonal compound having a perovskite structure and has a high dielectric constant. Generally, barium titanate is obtained by reacting a titanium material such as titanium dioxide with a barium material such as barium carbonate and synthesizing barium titanate.

A predetermined additive compound is added to the obtained dielectric powder according to the purpose. As additives to the dielectric layer 11, zirconium, hafnium, magnesium, manganese, molybdenum, vanadium, chromium, rare earth elements (yttrium, samarium, europium, gadolinium, terbium, dysprosium, holmium, erbium, thulium, and ytterbium) or an oxide of cobalt, nickel, lithium, boron, sodium, potassium or silicon, or a glass including cobalt, nickel, lithium, boron, sodium, potassium or silicon.

For example, a ceramic material is prepared by wet-mixing a compound containing an additive compound with a ceramic raw material powder, drying and pulverizing the mixture. For example, the ceramic material obtained as described above may be pulverized to adjust the particle size, if necessary, or may be combined with a classification process to adjust the particle size. Through the above steps, a dielectric material is obtained.

(Forming process of ceramic green sheet) Next, a binder such as polyvinyl butyral (PVB) resin, an organic solvent such as ethanol or toluene, and a plasticizer are added to the obtained dielectric material and wet-mixed. Using the obtained slurry, a ceramic green sheet 51 is formed on the substrate by, for example, a die coater method or a doctor blade method, and dried. The substrate is, for example, polyethylene terephthalate (PET) film. The process is not illustrated.

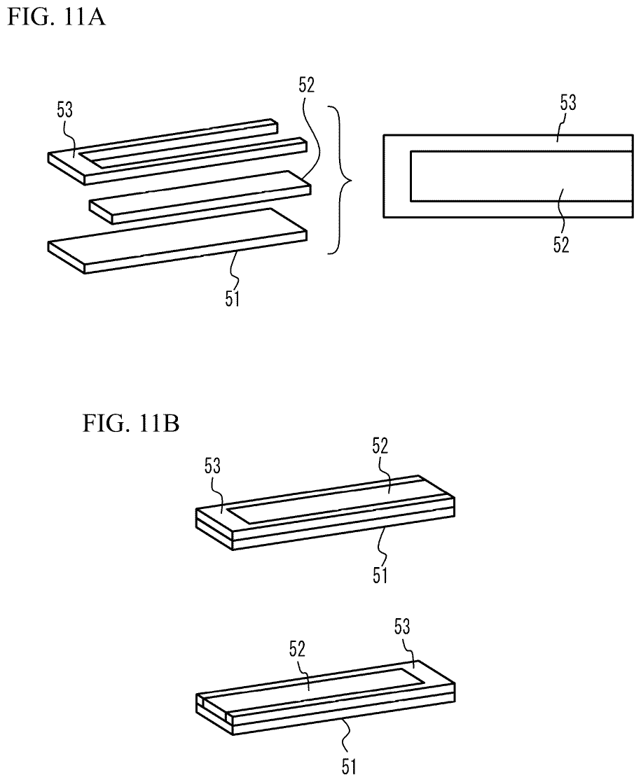

(Forming process of internal electrode pattern) Next, as illustrated in FIG. 11A, a metal conductive paste for forming internal electrodes containing an organic binder is printed on the surface of the ceramic green sheet 51 by screen printing, gravure printing, or the like to form internal electrodes. Thus, an internal electrode pattern 52 for layers is arranged. Ceramic particles may be added to the metal conductive paste as a co-material. The main component of the ceramic particles is not limited. However, it is preferable that the main component of the ceramic particles is the same as the main component of the dielectric layer 11.

Next, a binder such as ethyl cellulose and an organic solvent such as terpineol are added to the dielectric pattern material obtained in the making process of the raw material powder, and the mixture is kneaded in a roll mill to form a dielectric pattern paste for the reverse pattern layer. As illustrated in FIG. 11A, a dielectric pattern 53 is formed by printing the resulting slurry in the peripheral region, where the internal electrode pattern 52 is not printed, on the ceramic green sheet 51 to cause the dielectric pattern 53 and the internal electrode pattern 52 to form a flat surface. The ceramic green sheet 51 on which the internal electrode pattern 52 and the dielectric pattern 53 are printed is referred to as a stack unit.

Thereafter, as illustrated in FIG. 11B, a predetermined number of stack units are stacked so that the internal layers 12 and the dielectric layers 11 are alternated with each other and the end edges of the internal layers 12 are alternately exposed to both end faces in the length direction of the dielectric layer 11 so as to be alternately led out to a pair of the external electrodes 20a and 20b of different polarizations. For example, the number of the internal electrode pattern 52 is 100 to 500.

(Crimping process) A predetermined number (for example, 2 to 10) cover sheets are stacked on the stacked stack units and under the stacked stack units. After that, the stacked structure is thermally crimped. The cover sheet is also a green sheet including a ceramic powder.

(Chip production process) The obtained ceramic multilayer structure is cut into chips to a predetermined size.

(Firing process) The binder is removed from the resulting ceramic multilayer structure in N₂ atmosphere. After that, a metal paste to be the base layer of the external electrodes 20a and 20b is applied to the resulting ceramic multilayer by a dipping or the like. A first firing is performed for 5 minutes to 10 hours in a reducing atmosphere with an oxygen partial pressure of 10⁻¹² to 10⁻⁹ MPa in a temperature of 1160° C. to 1280° C. (for example, 1180° C. or more and 1230° C. or less). After that, the obtained multilayer chip 10 is subjected to vacuum pulse firing. In the vacuum pulse firing, for example, under conditions of 1000° C. and 10⁻³ MPa N₂, the O₂ partial pressure is increased to 10⁻³ MPa and maintained for 3 seconds, and this is repeated five times. This allows oxygen to be sent to the two side faces at both ends of the Y-axis direction of the multilayer chip 10. After that, a second firing is performed in an atmosphere with a higher oxygen partial pressure than the first firing. In the second firing, for example, the oxygen partial pressure in the atmosphere is preferably 0.015 atm or more, and more preferably 0.02 atm or more.

(Re-oxidation process) In order to return oxygen to the partially reduced main phase barium titanate of the dielectric layer 11 fired in a reducing atmosphere, N₂ and water vapor are mixed at about 1000° C. to an extent that the internal layer 12 is not oxidized, heat treatment may be performed in gas or in the atmosphere at 500° C. to 700° C. This process is called a re-oxidation process.

(Plating process) After that, metal layers such as copper, nickel, and tin may be formed on the external electrodes 20a and 20b by plating. Thus, the multilayer ceramic capacitor 100 is manufactured.

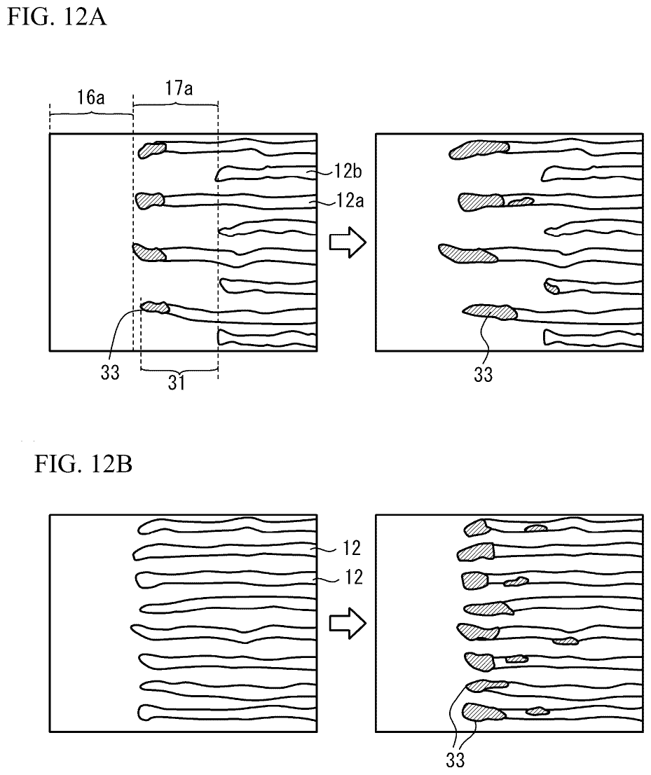

In the manufacturing method according to this embodiment, vacuum pulse firing is performed between the first firing and the second firing, so that the end of the first protruding section 31 of the first internal layer 12a can be oxidized by oxygen entering from the first side margin 16a to form the oxidized portion 33, as illustrated in FIG. 12A. Then, the second firing is performed at a higher oxygen partial pressure than the first firing, so that the oxidized portion 33 can be sufficiently formed. In this case, since oxidation progresses from the pre-formed oxidized portion 33, oxygen is captured by the oxidized portion 33, and the intrusion of oxygen into the capacity section 14 can be suppressed.

Note that, as illustrated in FIG. 12B, if the first protruding section 31 is not provided and vacuum pulse firing is not performed, the end of each internal layer will oxidize and expand, causing local structural deterioration, which will lead to reliability degradation and short circuits.

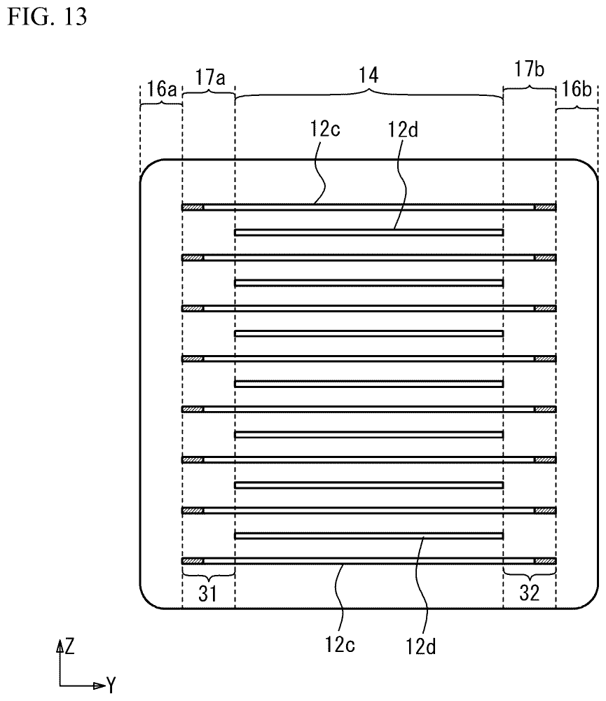

(Second Embodiment) In the first embodiment, the internal layer 12 includes the first internal layer 12a and the second internal layer 12b, but this is not limited thereto. In the second embodiment, as illustrated in FIG. 13, the internal layers 12 includes first internal layers 12c and second internal layers 12d. The first internal layer 12c and the second internal layer 12d are alternately stacked. The lowermost and uppermost internal layers 12 are the first internal layers 12c.

In the first embodiment, the first internal layer 12a includes the first protruding section 31, and the second internal layer 12b includes the second protruding section 32, but in this embodiment, the first internal layer 12c includes both the first protruding section 31 and the second protruding section 32. The second internal layer 12d does not include either the first protruding section 31 or the second protruding section 32.

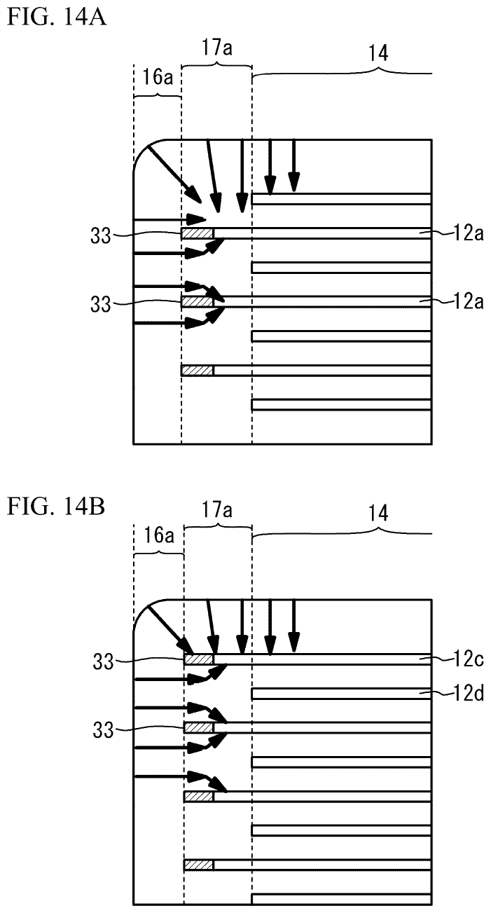

FIG. 14A is an enlarged view of the vicinity of the uppermost second internal layer 12b in the first side margin 16a of the first embodiment. In the configuration of FIG. 14A, oxygen can invade from the first side margin 16a and the upper cover layer 13. Since the uppermost second internal layer 12b does not have the first protruding section 31, oxygen can invade between the uppermost second internal layer 12b and the adjacent first internal layer 12a. In contrast, FIG. 14B is an enlarged view of the vicinity of the uppermost first internal layer 12c in the first side margin 16a of this embodiment. In the configuration of FIG. 14B, oxygen can invade from the first side margin 16a and the upper cover layer 13, but the invading oxygen is suppressed by the oxidized portion 33 of the first protruding section 31 of the uppermost first internal layer 12c.

In this embodiment, in the internal electrode formation process of FIG. 10, it is sufficient to form the internal electrode pattern 52 that corresponds to the shapes of the first internal layer 12c and the second internal layer 12d.

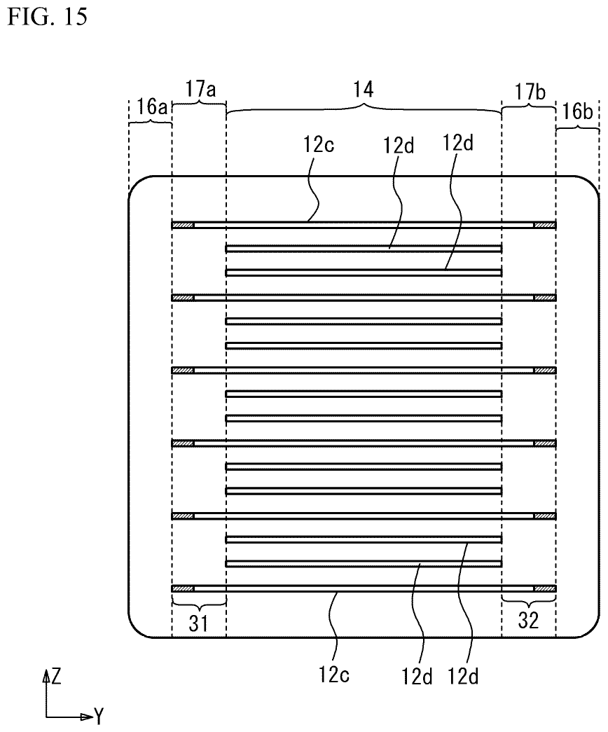

(Third Embodiment) In the second embodiment, the first internal layer 12c and the second internal layer 12d are alternately stacked, but this is not limited thereto. For example, as illustrated in FIG. 15, two or more of the second internal layers 12d may be stacked between the two adjacent first internal layers 12c. In the example of FIG. 11, two layers of the second internal layers 12d are disposed between each pair of the adjacent first internal layers 12c.

In this embodiment, too, it is sufficient to form the internal electrode pattern 52 corresponding to the shapes of the first internal layer 12c and the second internal layer 12d in the internal electrode formation process of FIG. 10.

Note that in each of the above embodiments, a multilayer ceramic capacitor has been described as an example of a multilayer ceramic electronic device, but the present invention is not limited thereto. For example, other multilayer ceramic electronic devices such as varistors and thermistors may be used.

### Example

The multilayer ceramic capacitors according to the above embodiment were fabricated and their characteristics were examined.

(Examples 1 to 4) A Ni internal electrode pattern of 15 μm thickness was printed on a dielectric green sheet of 3.0 μm thickness. A dielectric pattern was printed around the internal electrode pattern. A plurality of stack units were stacked so that the internal electrode patterns were alternately shifted in the X-axis direction and alternately shifted in the Y-axis direction, and then crimped and cut to obtain a ceramic multilayer structure. The total thickness in the Y-axis direction of the side margin and mixed section described in FIG. 5 was set to 150 μm. After that, the binder was removed, and the first firing was performed in a reducing atmosphere with an oxygen partial pressure of 10⁻¹² MPa to 10⁻⁹ MPa and 1160° C. to 1280° C., followed by vacuum pulse firing, and then the second firing was performed in an atmosphere with an oxygen concentration of 1.5%.

In the sample of Example 1, d_{T} was 9.0 μm, dₒ₁ was 3.1 μm, dₒ₂ was 1.0 μm, d_{w} was 2.1 μm, d_{w}/d_{T} was 23%, and dₒ₁/d_{w} was 150%. In the sample of Example 2, d_{T} was 9.0 μm, dₒ₁ was 2.9 μm, dₒ₂ was 0.0 μm, d_{w} was 4.8 μm, d_{w}/d_{T} was 53%, and dₒ₁/d_{w} was 62%. In the sample of Example 3, d_{T} was 9.0 μm, dₒ₁ was 3.1 μm, dₒ₂ was 0.0 μm, d_{w} was 10.3 μm, d_{w}/d_{T} was 114%, and dₒ₁/d_{w} was 30%. In the sample of Example 4, d_{T} was 9.0 μm, dₒ₁ was 3.1 μm, dₒ₂ was 0.0 μm, d_{w} was 20.2 μm, d_{w}/d_{T} was 224%, and dₒ₁/d_{w} was 15%.

(Examples 5 to 7) A Ni internal electrode pattern of 1.5 μm thickness was printed on a dielectric green sheet of 1.5 μm thickness. A dielectric pattern was printed around the internal electrode pattern. A plurality of stack units were stacked such that the internal electrode patterns were alternately shifted in the X-axis direction and alternately shifted in the Y-axis direction, and then the multilayer structure was crimped and cut to obtain a ceramic multilayer structure. The total thickness in the Y-axis direction of the side margin and the mixed section described in FIG. 5 was set to 150 μm. After that, the binder was removed, and then the first firing was performed in a reducing atmosphere with an oxygen partial pressure of 10⁻¹² MPa to 10⁻⁹ MPa and a temperature of 1160° C. to 1280° C., followed by vacuum pulse firing, and then the second firing in an atmosphere with an oxygen concentration of 2.0%.

In the sample of Example 5, d_{T} was 9.0 μm, dₒ₁ was 5.4 μm, dₒ₂ was 0.5 μm, d_{w} was 4.9 μm, d_{w}/d_{T} was 55%, and dₒ₁/d_{w} was 109%. In the sample of Example 6, d_{T} was 9.0 μm, dₒ₁ was 5.8 μm, dₒ₂ was 0.0 μm, d_{w} was 10.1 μm, d_{w}/d_{T} was 112%, and dₒ₁/d_{w} was 57%. In the sample of Example 7, d_{T} was 9.0 μm, dₒ₁ was 5.6 μm, dₒ₂ was 0.0 μm, d_{w} was 20.5 μm, d_{w}/d_{T} was 228%, and dₒ₁/d_{w} was 27%.

(Example 8) A Ni internal electrode pattern of 1.5 μm thickness was printed on a dielectric green sheet of 3.0 μm thickness. A dielectric pattern was printed around the internal electrode pattern. A plurality of stack units were stacked so that the internal electrode patterns were alternately shifted in the X-axis direction and alternately shifted in the Y-axis direction, and then crimped and cut to obtain a ceramic multilayer structure. Among the internal electrode patterns, the internal electrode patterns that were wider in the Y-axis direction were placed on the top layer, the bottom layer, and between them, and three layers of internal electrode patterns that were narrower in the Y-axis direction were sandwiched between two layers of the wider internal electrode patterns. The total thickness in the Y-axis direction of the side margin and the mixed section described in FIG. 5 was 150 μm. After that, the binder was removed, and then the first firing was performed in a reducing atmosphere with an oxygen partial pressure of 10⁻¹² MPa to 10⁻⁹ MPa and 1160° C. to 1280° C., followed by vacuum pulse firing, and then the second firing in an atmosphere with an oxygen concentration of 1.5%.

In the sample of Example 8, d_{T} was 13.5 μm, dₒ₁ was 3.0 μm, dₒ₂ was 0.0 μm, d_{w} was 10.3 μm, d_{w}/d_{T} was 76%, and dₒ₁/d_{w} was 29%.

(Examples 9 and 10) A Ni internal electrode pattern of 1.5 μm thickness was printed on a dielectric green sheet of 3.0 μm thickness. A dielectric pattern was printed around the internal electrode pattern. A plurality of stacking units were stacked so that the internal electrode patterns were alternately shifted in the X-axis direction and alternately shifted in the Y-axis direction, and then crimped and cut to obtain a ceramic multilayer structure. Among the internal electrode patterns, the internal electrode patterns with a wide width in the Y-axis direction were placed on the top layer, the bottom layer, and between them, and four layers of internal electrode patterns with a narrow width in the Y-axis direction were sandwiched between two layers of the wide internal electrode patterns. The total thickness in the Y-axis direction of the side margin and the mixed section described in FIG. 5 was set to 150 μm. After that, the binder was removed, and the first firing was performed in a reducing atmosphere with an oxygen partial pressure of 10⁻¹² MPa to 10⁻⁹ MPa and a temperature of 1160° C. to 1280° C., followed by vacuum pulse firing, and then the second firing in an atmosphere with an oxygen concentration of 1.5%.

In the sample of Example 9, d_{T} was 18.0 μm, dₒ₁ was 3.0 μm, dₒ₂ was 0.0 μm, d_{w} was 10.3 μm, d_{w}/d_{T} was 57%, and dₒ₁/d_{w} was 29%. In the sample of Example 10, d_{T} was 18.0 μm, dₒ₁ was 2.9 μm, dₒ₂ was 0.0 μm, d_{w} was 20.3 μm, d_{w}/d_{T} was 113%, and dₒ₁/d_{w} was 14%.

(Examples 11-13) A Ni internal electrode pattern of 1.5 μm thickness was printed on a dielectric green sheet of 5.0 μm thickness. A dielectric pattern was printed around the internal electrode pattern. A plurality of stack units were stacked so that the internal electrode patterns were alternately shifted in the X-axis direction and alternately shifted in the Y-axis direction, and then crimped and cut to obtain a ceramic multilayer structure. The total thickness in the Y-axis direction of the side margin and the mixed section described in FIG. 5 was set to 150 μm. After that, the binder was removed, and the first firing was performed in a reducing atmosphere with an oxygen partial pressure of 10⁻¹² MPa to 10⁻⁹ MPa and 1160° C. to 1280° C., followed by vacuum pulse firing, and then a second firing was performed in an atmosphere with an oxygen concentration of 1.5%.

In the sample of Example 11, d_{T} was 13.0 μm, dₒ₁ was 3.1 μm, dₒ₂ was 0.0 μm, d_{w} was 4.8 μm, d_{w}/d_{T} was 37%, and dₒ₁/d_{w} was 65%. In the sample of Example 12, d_{T} was 13.0 μm, dₒ₁ was 2.9 μm, dₒ₂ was 0.0 μm, d_{w} was 10.2 μm, d_{w}/d_{T} was 78%, and dₒ₁/d_{w} was 28%. In the sample of Example 13, d_{T} was 13.0 μm, dₒ₁ was 2.9 μm, dₒ₂ was 0.0 μm, d_{w} was 20.2 μm, d_{w}/d_{T} was 156%, and do1/d_{w} was 14%.

(Example 14) A Ni internal electrode pattern of 1.5 μm thickness was printed on a dielectric green sheet of 5.0 μm thickness. A dielectric pattern was printed around the internal electrode pattern. A plurality of stack units were stacked so that the internal electrode patterns were alternately shifted in the X-axis direction and alternately shifted in the Y-axis direction, then crimped and cut to obtain a ceramic multilayer structure. Among the internal electrode patterns, the internal electrode patterns with a wide width in the Y-axis direction were placed on the top layer, the bottom layer, and between them, and three layers of internal electrode patterns with a narrow width in the Y-axis direction were sandwiched between two layers of the wide internal electrode patterns. The total thickness in the Y-axis direction of the side margin and the mixed section described in FIG. 5 was set to 150 μm. After that, the binder was removed, and then the first firing was performed in a reducing atmosphere with an oxygen partial pressure of 10⁻¹² MPa to 10⁻⁹ MPa and a temperature of 1160° C. to 1280° C., followed by vacuum pulse firing, and then the second firing was performed in an atmosphere with an oxygen concentration of 1.5%.

In the sample of Example 14, d_{T} was 19.5 μm, dₒ₁ was 3.1 μm, dₒ₂ was 0.0 μm, d_{w} was 10.2 μm, d_{w}/d_{T} was 53%, and dₒ₁/d_{w} was 30%.

(Example 15) A Ni internal electrode pattern of 1.5 μm thickness was printed on a dielectric green sheet of 5.0 μm thickness. A dielectric pattern was printed around the internal electrode pattern. A plurality of stack units were stacked so that the internal electrode patterns were alternately shifted in the X-axis direction and alternately shifted in the Y-axis direction, and then crimped and cut to obtain a ceramic multilayer structure. Among the internal electrode patterns, the internal electrode patterns with a wide width in the Y-axis direction were arranged on the top layer, the bottom layer, and between them, and four layers of internal electrode patterns with a narrow width in the Y-axis direction were sandwiched between two layers of the wide internal electrode patterns. The total thickness in the Y-axis direction of the side margin and the mixed section described in FIG. 5 was set to 150 μm. After that, the binder was removed, and the first firing was performed in a reducing atmosphere with an oxygen partial pressure of 10⁻¹² MPa to 10⁻⁹ MPa and 1160° C. to 1280° C., followed by vacuum pulse firing, and then the second firing in an atmosphere with an oxygen concentration of 1.5%.

In the sample of Example 15, d_{T} was 26.0 μm, dₒ₁ was 3.0 μm, dₒ₂ was 0.0 μm, d_{w} was 19.1 μm, d_{w}/d_{T} was 74%, and dₒ₁/d_{w} was 16%.

(Comparative Example 1) A Ni internal electrode pattern of 1.5 μm thickness was printed on a dielectric green sheet of 3.0 μm thickness. A dielectric pattern was printed around the internal electrode pattern. A ceramic multilayer structure was obtained by stacking stack units with the internal electrode patterns alternately shifted in the X-axis direction, pressing, and cutting. The internal electrode patterns were not shifted in the Y-axis direction. The thickness of each side margin in the Y-axis direction was 150 μm. After that, the binder was removed, and the first firing was performed in a reducing atmosphere with an oxygen partial pressure of 10⁻¹² MPa to 10⁻⁹ MPa and a temperature of 1160° C. to 1280° C., followed by vacuum pulse firing, and then by second firing in an atmosphere with an oxygen concentration of 1.0%.

In the sample of Comparative Example 1, dₒ₁ was 1.0 μm, d_{w} was 0.0 μm, and d_{w}/d_{T} was 0%.

(Comparative Example 2) A Ni internal electrode pattern of 1.5 μm thickness was printed on a dielectric green sheet of 3.0 μm thickness. A dielectric pattern was printed around the internal electrode pattern. A plurality of stack units were stacked with the internal electrode patterns alternately shifted in the X-axis direction, crimped, and cut to obtain a ceramic multilayer structure. The internal electrode patterns were not shifted in the Y-axis direction. The thickness of each side margin in the Y-axis direction was set to 150 μm. After that, the binder was removed, and the first firing was performed in a reducing atmosphere with an oxygen partial pressure of 10⁻¹² MPa to 10⁻⁹ MPa and 1160° C. to 1280° C., followed by vacuum pulse firing, and then a second firing in an atmosphere with an oxygen concentration of 1.5%.

In the sample of Comparative Example 2, dₒ₁ was 2.9 μm, d_{w} was 0.0 μm, and d_{w}/d_{T} was 0%.

(Comparative Example 3) A Ni internal electrode pattern of 1.5 μm thickness was printed on a dielectric green sheet of 3.0 μm thickness. A dielectric pattern was printed around the internal electrode pattern. A plurality of stack units were stacked with the internal electrode patterns alternately shifted in the X-axis direction, crimped, and cut to obtain a ceramic multilayer structure. The internal electrode patterns were not shifted in the Y-axis direction. The thickness of each side margin in the Y-axis direction was set to 150 μm. After that, the binder was removed, and the first firing was performed in a reducing atmosphere with an oxygen partial pressure of 10⁻¹² MPa to 10⁻⁹ MPa and 1160° C. to 1280° C., followed by vacuum pulse firing, and then a second firing in an atmosphere with an oxygen concentration of 2.0%.

In the sample of Comparative Example 3, dₒ₁ was 5.7 μm, d_{w} was 0.0 μm, and d_{w}/d_{T} was 0%.

(Comparative Examples 4 to 6) In Comparative Examples 4 and 5, a Ni internal electrode pattern of 1.5 μm thickness was printed on a dielectric green sheet of 3.0 μm thickness. In Comparative Example 6, a Ni internal electrode pattern of 1.5 μm thickness was printed on a dielectric green sheet of 5.0 μm thickness. A dielectric pattern was printed around the internal electrode pattern. A ceramic multilayer structure was obtained by stacking stack units so that the internal electrode patterns were alternately shifted in the X-axis direction, crimping, and cutting. The internal electrode patterns were not shifted in the Y-axis direction. In Comparative Example 4, the thickness of each side margin in the Y-axis direction was 300 μm. In Comparative Example 5, the thickness of each side margin in the Y-axis direction was 500 μm. In Comparative Example 6, the thickness of each side margin in the Y-axis direction was 150 μm. After that, the binder was removed, and then the first firing was performed in a reducing atmosphere with an oxygen partial pressure of 10⁻¹² MPa to 10⁻⁹ MPa and a temperature of 1160° C. to 1280° C., followed by vacuum pulse firing, and then a second firing was performed in an atmosphere with an oxygen concentration of 1.5%.

In the sample of Comparative Example 4, dₒ₁ was 0.9 μm, d_{w} was 0.0 μm, and d_{w}/d_{T} was 0%. In the sample of Comparative Example 5, dₒ₁ was 0.2 μm, d_{w} was 0.0 μm, and d_{w}/d_{T} was 0%. In the sample of Comparative Example 6, dₒ₁ was 3.1 μm, d_{w} was 0.0 μm, and d_{w}/d_{T} was 0%.

The manufacturing conditions and measurement results of Examples 1 to 15 and Comparative Examples 1 to 6 are shown in Table 1.

TABLE 1

| | THICKNESS | THICKNESS | | | THICKNESS |
|---|---|---|---|---|---|
| | OF | OF | | | OF |
| | GREEN | INTERNAL | | | SIDE |
| | SHEET | LAYER | | FIRING | MARGIN |
| | (μm) | (μm) | SHIFT | ATMOSPHERE | (μm) |
| COMPARATIVE | 3.0 | 1.5 | NONE | 1.0% | 150 |
| EXAMPLE 1 | | | | | |
| COMPARATIVE | 3.0 | 1.5 | NONE | 1.5% | 150 |
| EXAMPLE 2 | | | | | |
| COMPARATIVE | 3.0 | 1.5 | NONE | 2.0% | 150 |
| EXAMPLE 3 | | | | | |
| COMPARATIVE | 3.0 | 1.5 | NONE | 1.5% | 300 |
| EXAMPLE 4 | | | | | |
| COMPARATIVE | 3.0 | 1.5 | NONE | 1.5% | 500 |
| EXAMPLE 5 | | | | | |
| COMPARATIVE | 5.0 | 1.5 | NONE | 1.5% | 150 |
| EXAMPLE 6 | | | | | |
| EXAMPLE 1 | 3.0 | 1.5 | ALTER- | 1.5% | 150 |
| | | | NATING | | |
| EXAMPLE 2 | 3.0 | 1.5 | ALTER- | 1,5% | 150 |
| | | | NATING | | |
| EXAMPLE 3 | 3.0 | 1.5 | ALTER- | 1.5% | 150 |
| | | | NATING | | |
| EXAMPLE 4 | 3.0 | 1.5 | ALTER- | 1.5% | 150 |
| | | | NATING | | |
| EXAMPLE 5 | 3.0 | 1.5 | ALTER- | 2.0% | 150 |
| | | | NATING | | |
| EXAMPLE 6 | 3.0 | 1.5 | ALTER- | 2.0% | 150 |
| | | | NATING | | |
| EXAMPLE 7 | 3.0 | 1.5 | ALTER- | 2.0% | 150 |
| | | | NATING | | |
| EXAMPLE 8 | 3.0 | 1.5 | THREE | 1.5% | 150 |
| | | | LAYERS | | |
| EXAMPLE 9 | 3.0 | 1.5 | FOUR | 1.5% | 150 |
| | | | LAYERS | | |
| EXAMPLE 10 | 3.0 | 1.5 | FOUR | 1.5% | 150 |
| | | | LAYERS | | |
| EXAMPLE 11 | 5.0 | 1.5 | ALTER- | 1.5% | 150 |
| | | | NATING | | |
| EXAMPLE 12 | 5.0 | 1.5 | ALTER- | 1.5% | 150 |
| | | | NATING | | |
| EXAMPLE 13 | 5.0 | 1.5 | ALTER- | 1.5% | 150 |
| | | | NATING | | |
| EXAMPLE 14 | 5.0 | 1.5 | THREE | 1.5% | 150 |
| | | | LAYERS | | |
| EXAMPLE 15 | 5.0 | 1.5 | FOUR | 1.5% | 150 |
| | | | LAYERS | | |

(High-temperature load test) A high-temperature load test was carried out on the samples of Examples 1 to 15 and Comparative Examples 1 to 6, and the failure rate was examined. In the high-temperature load test, the applied voltage was set to 10 V/μm in electric field strength, and the samples were left at 125° C. for 100 hours. The number of failures out of 1000 pieces put in was calculated as the failure rate. If the failure rate was 1/1000 or less, the high temperature load test was judged as good “∘”. If the failure rate was 2/1000 or more and 7/1000 or less, the high temperature load test was judged as somewhat good “Δ”. If the failure rate was 8/1000 or more, the high temperature load test was judged as somewhat poor “x”. The results are shown in Table 2.

(Electrical characteristics) The electrical characteristics of the samples of Examples 1 to 15 and Comparative Examples 1 to 6 were examined. Specifically, the electrostatic capacity was measured. If the electrostatic capacity was 8 μF or more as a result of the measurement, it was judged as good “∘”, and if the electrostatic capacity was not less than 8 μF, it was judged as bad “x”. The results are shown in Table 2.

(Overall judgment) If both the high temperature load test and the electrical characteristics were judged as good “∘”, the overall judgment was judged as good “∘”. If neither the high-temperature load test nor the electrical characteristics were judged as “x” but included “Δ”, the overall judgment was judged as somewhat good “Δ”. If at least one of the high-temperature load test and the electrical characteristics was judged as “x”, the overall judgment was judged as bad “x”.

TABLE 2

| | | | | | | | HIGH TEMPERATURE | | | |
|---|---|---|---|---|---|---|---|---|---|---|
| | d_{T} | dₒ₁ | dₒ₂ | d_{w} | d_{w}/d_{T} | dₒ₁/d_{w} | LOAD TEST | | ELECTRICAL | |
| | (μm) | (μm) | (μm) | (μm) | (%) | (%) | (FAILURE | | CHARACTERISTIC | JUDGE |
| COMPARATIVE | — | 1.0 | — | 0.0 | 0 | — | 5/1000 | Δ | X | X |
| EXAMPLE 1 | | | | | | | | | | |
| COMPARATIVE | — | 2.9 | — | 0.0 | 0 | — | 20/1000 | X | ◯ | X |
| EXAMPLE 2 | | | | | | | | | | |
| COMPARATIVE | — | 5.7 | — | 0.0 | 0 | — | 19/1000 | X | ◯ | X |
| EXAMPLE 3 | | | | | | | | | | |
| COMPARATIVE | — | 0.9 | — | 0.0 | 0 | — | 6/1000 | Δ | X | X |
| EXAMPLE 4 | | | | | | | | | | |
| COMPARATIVE | — | 0.2 | — | 0.0 | 0 | — | 0/1000 | ◯ | X | X |
| EXAMPLE 5 | | | | | | | | | | |
| COMPARATIVE | — | 3.1 | — | 0.0 | 0 | — | 20/1000 | X | ◯ | X |
| EXAMPLE 6 | | | | | | | | | | |
| EXAMPLE 1 | 9.0 | 3.1 | 1.0 | 2.1 | 23 | 150 | 7/1000 | Δ | ◯ | Δ |
| EXAMPLE 2 | 9.0 | 2.9 | 0.0 | 4.8 | 53 | 62 | 0/1000 | ◯ | ◯ | ◯ |
| EXAMPLE 3 | 9.0 | 3.1 | 0.0 | 10.3 | 114 | 30 | 0/1000 | ◯ | ◯ | ◯ |
| EXAMPLE 4 | 9.0 | 3.1 | 0.0 | 20.2 | 224 | 15 | 0/1000 | ◯ | ◯ | ◯ |
| EXAMPLE 5 | 9.0 | 5.4 | 0.5 | 4.9 | 55 | 109 | 5/1000 | Δ | ◯ | Δ |
| EXAMPLE 6 | 9.0 | 5.8 | 0.0 | 10.1 | 112 | 57 | 0/1000 | ◯ | ◯ | ◯ |
| EXAMPLE 7 | 9.0 | 5.6 | 0.0 | 20.5 | 228 | 27 | 0/1000 | ◯ | ◯ | ◯ |
| EXAMPLE 8 | 13.5 | 3.0 | 0.0 | 10.3 | 76 | 29 | 0/1000 | ◯ | ◯ | ◯ |
| EXAMPLE 9 | 18.0 | 3.0 | 0.0 | 10.3 | 57 | 29 | 1/1000 | ◯ | ◯ | ◯ |
| EXAMPLE 10 | 18.0 | 2.9 | 0.0 | 20.3 | 113 | 14 | 0/1000 | ◯ | ◯ | ◯ |
| EXAMPLE 11 | 13.0 | 3.1 | 0.0 | 4.8 | 37 | 65 | 6/1000 | Δ | ◯ | Δ |
| EXAMPLE 12 | 13.0 | 2.9 | 0.0 | 10.2 | 78 | 28 | 0/1000 | ◯ | ◯ | ◯ |
| EXAMPLE 13 | 13.0 | 2.9 | 0.0 | 20.2 | 156 | 14 | 0/1000 | ◯ | ◯ | ◯ |
| EXAMPLE 14 | 19.5 | 3.1 | 0.0 | 10.2 | 53 | 30 | 1/1000 | ◯ | ◯ | ◯ |
| EXAMPLE 15 | 26.0 | 3.0 | 0.0 | 19.1 | 74 | 16 | 0/1000 | ◯ | ◯ | ◯ |

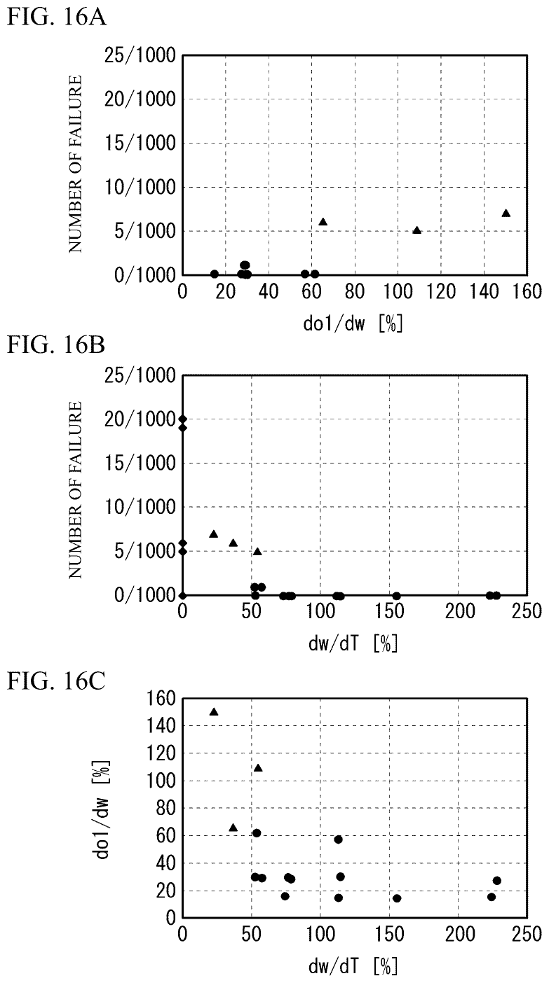

FIG. 16A is a graph illustrating the relationship between dₒ₁/d_{w} and the number of failures in the high-temperature load test. FIG. 16B is a graph illustrating the relationship between d_{w}/d_{T} and the number of failures in the high-temperature load test. Summarizing these results, as illustrated in FIG. 16C, it can be seen that the number of failures can be reduced when d_{w}/d_{T} is 50% or more and dₒ₁/d_{w} is less than 100%.

Although the embodiments of the present invention have been described in detail, it is to be understood that the various change, substitutions, and alterations could be made hereto without departing from the spirit and scope of the invention.

What is claimed is:

1. A ceramic electronic device comprising:
a multilayer chip including a multilayer portion in which each of a plurality of dielectric layers and each of a plurality of internal layers are alternately stacked;
wherein each of the plurality of internal layers is alternately extracted to two end faces of the multilayer chip opposite to each other,
wherein the multilayer chip includes side margins outside of a capacity section in a third direction which is orthogonal to a first direction in which the plurality of internal layers face each other and a second direction in which the two end faces are opposite to each other, the capacity section being a section in which the plurality of internal layers face each other,
wherein the plurality of internal layers include a first internal layer and a second internal layer which are included in the capacity section and include a metal component,
wherein the first internal layer includes a protruding section which protrudes toward outside from the capacity section in the third direction,
wherein the protruding section includes an oxidized portion of the metal component, and
wherein a relationship dₒ₁>dₒ₂ is satisfied when a length of the oxidized portion of the protruding section is dₒ₁ and a length of an oxidized portion at an end of the second internal layer on a side of one of the side margins is dₒ₂ in a cross section along the second direction and the third direction.

2. The ceramic electronic device as claimed in claim 1, wherein a relationship of d_{T}×0.5<d_{w} is satisfied, when a length of the protruding section is d_{w}, and an interval between protruding sections of two of first internal layers adjacent to each other in the first direction is d_{T} in the cross section.

3. The ceramic electronic device as claimed in claim 1, wherein a relationship of d_{T}×0.2<dₒ₁<d_{w}×1.0 is satisfied, when a length of the protruding section is d_{w} and an interval between protruding sections of two of first internal layers adjacent to each other in the first direction is d_{T} in the cross section.

4. The ceramic electronic device as claimed in claim 1, wherein d_{w}/d_{T} is 50% or more and dₒ₁/d_{w} is less than 100%, when a length of the protruding section is d_{w} and an interval between protruding sections of two of first internal layers adjacent to each other in the first direction is d_{T} in the cross section.

5. The ceramic electronic device as claimed in claim 1, wherein the plurality of internal layers are alternately shifted in the third direction.

6. The ceramic electronic device as claimed in claim 1,
wherein the plurality of internal layers includes two or more first internal layers,
wherein the first internal layers includes the protruding section located outside of the second internal layer toward both of the side margins, and
wherein two outermost layers of the plurality of internal layers in the first direction are the first internal layers.

7. The ceramic electronic device as claimed in claim 1, wherein a thickness to an outside surface of one of the side margins from an end of the capacity section is 150 μm or less.

8. The ceramic electronic device as claimed in claim 1,
wherein, in the first internal layer, a first section is located on the side of the capacity section from a predetermined position in the third direction, and a second section is located on the side of the side margin from the predetermined position,
wherein a main component of the first section is a non-oxidized metal or alloy, and
wherein the oxidized portion is located in at least a portion of the second section.

9. The ceramic electronic device as claimed in claim 1,
wherein, in both of the first internal layer and the second internal layer, first sections are located on the side of the capacity section from a predetermined position in the third direction, and second sections are located on the side of the side margin from the predetermined position,
wherein a main component of the first sections is a non-oxidized metal or alloy, and
wherein the oxidized portion is located in at least a portion of the second sections.

10. A manufacturing method of a ceramic electronic device comprising:
forming an internal electrode pattern on each of dielectric green sheets;
forming a dielectric pattern around the internal electrode pattern on each of the dielectric green sheets;
obtaining a multilayer structure by, in a first direction, stacking each of the dielectric green sheets on which the internal electrode pattern and the dielectric pattern are formed, so that an end of the internal electrode pattern is alternately shifted in a second direction, and at least two of the internal electrode pattern adjacent to each other is shifted in a third direction orthogonal to the first direction and the second direction;
performing a first firing of the multilayer structure;
performing a vacuum pulse firing of the multilayer structure after the first firing; and
performing a second firing of the multilayer structure after the vacuum pulse firing, at an oxygen partial pressure higher than that of the first firing.
